(19) United States
(12) Patent Application Publication
(10) Pub. No.: US 2023/0054416 A1
(43) Pub. Date: Feb. 23, 2023

(54) MACHINE AND METHOD FOR THE MILLING OR GRINDING OF TOOTHED RACKS

(71) Applicant: Georg Kesel GmbH & Co. KG, Kempten (DE)

(72) Inventor: Martin Klug, Kempten (DE)

(21) Appl. No.: 17/884,626

(22) Filed: Aug. 10, 2022

(30) Foreign Application Priority Data
Aug. 19, 2021 (DE) 10 2021 121 576.5

(51) Int. Cl. B23F 1/06; B23F 1/02

(52) U.S. Cl. CPC B23F 1/06; B23F 1/02

(57) ABSTRACT

A machine for the milling or grinding of toothed racks, having a workspace, in which a machining head carrying milling and/or grinding tools is movably arranged is provided. The machine further has a first preparation area arranged on a first side of the workspace, which has a first workpiece table reversibly movable from the first preparation area into the workspace, and which for its part has first positioning means for workpieces. The machine has a second preparation area, which is arranged on a second side of the workspace, and has a second workpiece table which can be reversibly moved from the second preparation area into the workspace, and which for its part has second positioning means for workpieces. A corresponding method is also provided.

This U.S. patent application claims priority to German patent application no. 10 2021 121 576.5, filed Aug. 19, 2021, the entire contents of which is incorporated herein by reference in its entirety.

### BACKGROUND

### 1. Technical Field

The present invention relates to a machine for the milling or grinding of toothed racks, together with a corresponding method.

### 2. Related Art

Toothed racks primarily serve to convert rotational movements into linear movements, and vice versa. For this purpose, they have straight teeth, or teeth oriented at an angle of 19°31′42″ obliquely to the longitudinal axis of the toothed rack, which teeth are primarily designed with an involute, cycloid, or possibly also conchoid geometry, and must be ground or milled with an appropriate precision. Here, tolerances with a single pitch deviation of 3 to 5 μm are, for example, possible for precision toothed racks of the highest classes of accuracy.

Lengths of toothed racks are usually 0.5 m, 1 m and 2 m. Bespoke lengths are possible, but are seldom manufactured in comparison to the usual lengths. Toothed racks are a mass-produced product, which are mainly manufactured with a length of 1 m. Precision toothed racks of the highest classes of accuracy usually have no lengths above 0.5 m, as otherwise the errors that inevitably occur when grinding/milling the teeth to the final dimensions would have accumulated too far to still be able to maintain the required precision.

Machines for the milling or grinding of such toothed racks have an enclosed workspace, in which the grinding or milling tool is guided over the workpiece in the course of machining. In order to be able also to machine helical gears, the machining head of the machine holding the tools may be adjustable in angle. A plurality of toothed racks is usually combined into one temporary workpiece and machined in one operation. For this purpose, they are usually held and positioned magnetically on a workpiece table, whereby the positioning in particular is achieved by placing them against appropriate stops that can be adjusted in position to suit different toothed rack lengths. The tool table is loaded outside the enclosed workspace in a preparation area, whereby the tool table is moved from the workspace into the preparation area for this purpose. The tool table, loaded with machined workpieces, is moved out of the enclosed workspace into the preparation area. There, the machined toothed racks are removed, the workpiece table is cleaned of chips and coolant/lubricant residues, and is then reloaded with toothed rack blanks. The next machining operation then takes place. The loading and unloading times, including the times for the cleaning of the clamping surface of the workpiece table, amount to several minutes, depending on the number of toothed racks clamped, with the result that such machines have long downtimes, which inevitably result in higher cycle times, and thus also higher unit costs for the toothed racks. Furthermore, the dimensions of the workpiece table in the machine also determine the maximum length of the toothed racks that can be machined, so that in overall terms the machines of known art cannot be regarded as optimally productive.

### SUMMARY

The present invention has therefore set itself the object of specifying a more productive machine.

The object for the device is achieved by a machine for the milling or grinding of toothed racks, having a workspace in which a machining head carrying milling and/or grinding tools is movably arranged, further having a first preparation area arranged on a first side of the workspace, which has a first workpiece table that can be reversibly moved from the first preparation area into the workspace, which for its part has first positioning means for workpieces, whereby the machine has a second preparation area arranged on a second side of the workspace, which second preparation area has a second workpiece table, which can be reversibly moved out of the second preparation area into the workspace, and which for its part has second positioning means for workpieces. The first and second workpiece tables are preferably designed such that they can be coupled to one another.

Very advantageously, the invention proposes a doubling of the preparation areas and the workpiece tables, so that in particular an intermittent mode of operation of the machine is made possible, which thus enables a practically continuous operation of the tools. While one workpiece table is in the workspace, the second can be unloaded, cleaned, and reloaded, in its associated preparation area during the machine prime time, and is thus immediately available for movement into the workspace after completion of the processing of the workpieces on the first workpiece table. This inventive configuration also reduces the space required in comparison to that for two machines with one workpiece table each, reduces the number of parts, and facilitates operation, since one operator does not have to work on two machines at the same time.

Very advantageously, the invention also enables the coupling of two workpiece tables to form a unit, which can preferably be moved collectively. In this way, longer toothed racks can be machined with the inventive machine without any modifications, and the acquisition of appropriate bespoke machines is unnecessary, as is any modification of the machine by the replacement of a short workpiece table with an appropriately longer one, if such a replacement is possible at all on the machine in question. When the workpiece tables are moved together and coupled, the workpieces are either loaded and unloaded in an appropriately long preparation area. or in the workspace itself, if the preparation areas are only designed for the length of one workpiece table. In this case, there is no need to move the coupled workpiece table collectively.

In one configuration of the invention, provision is made for a workpiece table to have a drive, preferably two drives, in particular drives that operate in opposition to one another. For the required accuracy when machining the workpiece by means of milling, one drive per workpiece table is sufficient, but when machining by means of grinding, two drives are desirable.

If there is only one drive, the latter moves the tool table into its respective end positions in the workspace and in the preparation area, wherein clamping units are additionally provided, which clamp the workpiece table in its respective end positions, so that it is precisely positioned both during the machining process and also during the loading/unloading process.

With only one drive and coupled tool tables, it is preferable to operate the two drives in a “slave-master” mode with angular synchronicity. Here, depending on the position of the master drive, the slave axis assigned to the master is controlled such that it moves in absolute synchronicity with the master.

In the case of two drives per workpiece table, and thus primarily for grinding applications, both drives, in single table operation, move the workpiece table in the angular synchronous manner described. In its end positions, especially in the working position, one drive operates with about 15% of its maximum torque in the opposite direction to the other drive, so as to keep the workpiece table in an exact position for the grinding process. In the case of coupled workpiece operation, all four drives move the coupled table in the angular synchronous manner described. In the end position of the table, one drive of each workpiece table operates with 15% of its maximum torque in the opposite direction to the other, so as to achieve the above-described effect of exact positioning. This opposite drive direction eliminates the backlash between the pinion and rack of the two drives, which results in a significantly higher positioning accuracy of the tool table in the machining position, and thus a higher machining accuracy. In this manner, the two workpiece tables are held together with zero backlash, without the need for special coupling mechanisms or devices between them. This avoids design complexity, and a release device for the coupling mechanism can also advantageously be omitted.

In a development of the invention, provision is made for the drives of the workpiece tables to have the rack-and-pinion connections already cited.

If a splash guard is provided between the workspace and the preparation area, chips and cooling lubricant cannot escape from the workspace, or can only escape to a small extent to hinder a user during the loading/unloading. This is also helped by the fact that a wall with a passage opening that is only slightly larger than the outline of a workpiece table loaded with workpieces is provided between the workspace and the preparation area. The provision of a light barrier on the side of a preparation area facing the user serves to ensure the operational safety of the machine.

Finally, in one development of the invention, the provision of a robot in a preparation area is envisaged, which robot is designed for the loading of the workpiece table with workpieces, cleaning of the workpiece table, and the removal of processed workpieces from the workpiece table. For this purpose, it advantageously has a rinsing nozzle and a suction nozzle, with which it first rinses away any chips present on the workpiece table, and then sucks off any cooling/lubricating liquid present on the table.

In accordance with the invention, the machine can be constructed according to the modular principle in different lengths, whereby workpiece tables are used, in particular tables with lengths of 1,250 mm, 1,750 mm, 2,250 mm and 2,750 mm. The inventive machine can be fitted with two workpiece tables of the same length, as well as with two tables of different lengths. In the first case, toothed racks of two different lengths can be machined, in the second case toothed racks of three different lengths. However, machines with two workpiece tables of the same length are preferred.

The object of the method is achieved by a milling or grinding method for toothed racks, in which in a step a) a machining head carrying milling or grinding tools is operating on a workpiece located in its radius of action, and is arranged on a first workpiece table, while on a second workpiece table, outside the radius of action of the machining head, previously machined workpieces are unloaded or cleaned, or unmachined workpieces are loaded, and in which, in a step b), the first workpiece table is moved out of the radius of action of the machining head, after the machining of the workpieces arranged on it has been completed, and the second workpiece table loaded with workpieces to be machined is moved into the radius of action of the machining head.

### BRIEF DESCRIPTION OF THE DRAWINGS

In what follows the invention is explained in more detail with the aid of the figures of a drawing of an example of an embodiment. Here:

FIG. 1a: shows a schematic frontal view of a machine according to the invention for the milling or grinding of toothed racks,

FIG. 1b: shows an enclosed workspace containing a movable machining head which carries milling and/or grinding tools, and

FIG. 2: shows a schematic view of a workpiece table.

### DETAILED DESCRIPTION OF EXAMPLE EMBODIMENTS

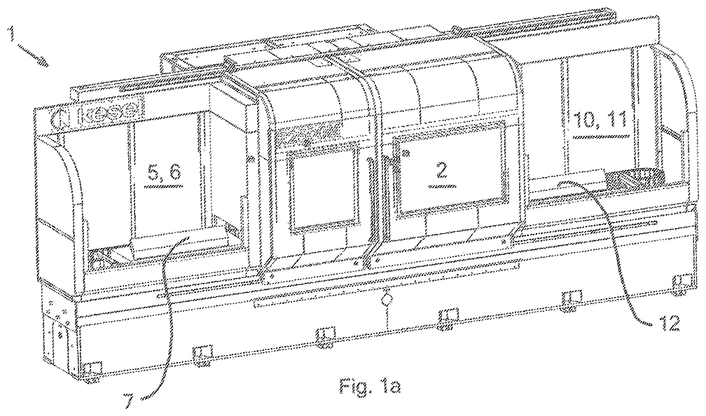

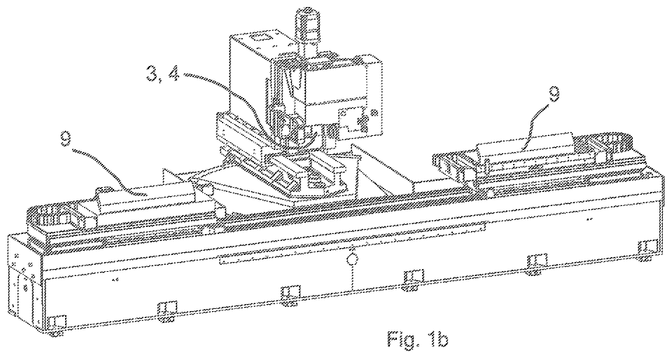

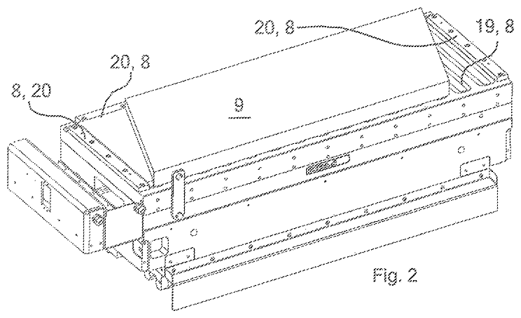

FIG. 1a shows a schematic frontal view of a machine 1 according to the invention for the milling or grinding of toothed racks. An enclosed workspace 2 can be seen, in which is arranged a movable machining head 4, which carries milling and/or grinding tools 3 (see FIG. 1b), and which in particular is also designed to pivot in such a way that helical toothed racks can be ground or milled. The enclosed workspace 2 is configured to be large enough to be able to machine toothed racks of 2 m length, or even longer racks. On the left-hand and thus the first side 5 of the workspace 2 there is a first preparation area 6, in which a first workpiece table 7 is arranged so that it can be moved towards and away from the workspace 2. The workpiece table 7 has magnetic holders 19, together with rear and side stops 20 for workpieces 9, which together form the first positioning means 8 (see FIG. 2).

On a second side 10 on the right-hand side near the workspace 2, a second preparation area 11 with a second workpiece table 12 is arranged, which carries second positioning means 13, and in overall terms is designed to be the same as the first preparation area 6. In accordance with the invention, however, both workpiece tables 7, 12 can also be designed differently from one another, in particular with regard to their length that can be used for workpieces, although two workpiece tables of the same length are preferred.

What is illustrated is an inventive machine with two workpiece tables of equal length, each 1,250 mm long, which can therefore also be coupled to enable machining of toothed racks that are 2,500 mm long.

Not illustrated is an optional robot in front of the first preparation area 6, which is designed to carry out the above-described operations on the workpiece table automatically and, for this purpose, to remove the unmachined toothed racks arranged on pallets in its range of action, to arrange them on the workpiece table, to remove them again after machining has been completed, and to clean and reload the table. In this way, the daily machine running times can be extended without increased personnel costs. In accordance with the invention, there is also a configuration with one robot for each preparation area.

FIG. 2 shows schematically a workpiece table 7 in detail. Magnetic holders 19 and stops 20, which together form the positioning means 8, can be seen. Concealed on the underside of the workpiece table 7 are the two drives 14, as well as a toothed rack which is part of the drive, whereby the pinion is the driven component. The drive is preferably an electric drive, in particular an electric motor. The workpiece table 7 is designed with a smooth surface in the direction of the workpieces 9, so that the T-slots that are otherwise usual there cannot become clogged with chips, and covers for the T-slots are also avoided.

A bellows seal, not illustrated here, between the workpiece table 7 and its substructure, also not illustrated here, which supports the drive, the toothed rack and the pinion as described, protects these from contamination.

Very advantageously, the duplication of the preparation areas of the machine for milling or grinding toothed racks and thus of the inventive workpiece tables often makes it possible to halve the downtimes, and thus significantly increases the economy and efficiency of the inventive machine compared to conventional machines. The possibility of coupling the two workpiece tables also contributes to this, in terms of providing the ability to machine toothed racks of different lengths without any modification of the machine.

1. A machine for the milling or grinding of toothed racks, having a workspace in which a machining head carrying milling and/or grinding tools is movably arranged, further having a first preparation area arranged on a first side of the workspace, which has a first workpiece table which can be reversibly moved out of the first preparation area into the workspace, and which for its part has first positioning means for workpieces, wherein the machine has a second preparation area arranged on a second side of the workspace, which second preparation area has a second workpiece table, which can be reversibly moved out of the second preparation area into the workspace, and which for its part has second positioning means for workpieces.

2. A machine according to claim 1, wherein the first and second workpiece table can be coupled to one another.

3. A machine according to claim 1, wherein a workpiece table has a drive.

4. A machine according to claim 1, wherein the drives have rack-and-pinion connections.

5. A machine according to claim 1, wherein the machine has a splash guard between the workspace and the preparation area, and/or a wall is provided between the workspace and the preparation area, with a passage opening that is only slightly larger than the outline of a workpiece table loaded with workpieces, and/or has a light barrier on the side of a preparation area facing a user.

6. A machine according to claim 1, wherein the machine has a robot in a preparation area, which is designed for the loading of the workpiece table with workpieces, cleaning of the workpiece table, and the removal of machined workpieces from the workpiece table.

7. A machine according to claim 1, wherein the machine has workpiece tables.

8. A method for the milling or grinding of toothed racks, in which
in a step a), a machining head carrying milling or grinding tools is machining workpieces located within its radius of action and arranged on a first workpiece table, while previously machined workpieces are being unloaded from a second workpiece table outside the radius of action of the machining head, or the second workpiece table is being cleaned, or is being loaded with unmachined workpieces, and in which
in a step b), the first workpiece table is moved out of the radius of action of the machining head, after the machining of the workpieces arranged on it has been completed, and the second workpiece table loaded with workpieces to be machined is moved into the radius of action of the machining head.

9. A machine according to claim 2, wherein the first and second workpiece table are designed to be movable in a coupled manner.

10. A machine according to claim 3, wherein the workpiece table has two drives that operate in opposition to one another or operate with angular synchronicity.

11. A machine according to claim 7, wherein the machine has workpiece tables with lengths of 1,250 mm, 1,750 mm, 2,250 mm and 2,750 mm.
